(19) United States
(12) Patent Application Publication
(10) Pub. No.: US 2026/0027630 A1
(43) Pub. Date: Jan. 29, 2026

(54) TOOL FOR MACHINING A WORKPIECE, IN PARTICULAR DEEP-HOLE DRILL, TOOL SYSTEM AND METHOD

(71) Applicant: Gutekunst GmbH, Römerstein-Zainingen (DE)

(72) Inventors: Manfred Egner, Römerstein-Zainingen (DE); Florian Belschner, Römerstein-Zainingen (DE); Rocco Eisseler, Stuttgart (DE); Johannes Ramme, Stuttgart (DE); Hans-Christian Moehring, Stuttgart (DE)

(73) Assignee: Gutekunst GmbH, Römerstein-Zainingen (DE)

(21) Appl. No.: 19/301,607

(22) Filed: Aug. 15, 2025

Related U.S. Application Data
(63) Continuation of application No. PCT/EP2024/051382, filed on Jan. 22, 2024.

(30) Foreign Application Priority Data
Feb. 16, 2023 (DE) 10 2023 103 844.3

(51) Int. Cl. B23B 51/06; B23B 49/00

(52) U.S. Cl. CPC B23B 51/063; B23B 49/00

(57) ABSTRACT

A tool for machining a workpiece includes an elongated shaft that has a first shaft end and a second shaft end opposite the first shaft end. A tool head is arranged at the second shaft end. The elongated shaft includes a measuring channel for optical measuring radiation that extends from the first shaft end to the second shaft end. The measuring channel includes an optical measuring surface at an end that faces the second shaft end. The optical measuring surface is configured to reflect optical measuring radiation coupled in via the first shaft end at least partially back to the first shaft end. The optical measuring surface is also configured to vary a property of back-reflected measuring radiation as a function of a relative position of the first shaft end with respect to the second shaft end.

The present invention relates to a tool for machining a workpiece, in particular a deep-hole drill, as well as a corresponding system and method, in particular for deep-hole drilling.

Deep drilling, also known as deep-hole drilling or deep-hole boring, is part of modern (cutting or chip formation) machining technology, particularly in metalworking. A deep drill is used, for example, to machine camshafts, drive shafts, injectors, or drill rods in the automotive technology and filling tubes, ejectors, nozzles, etc. in the food industry.

Deep drilling is a special type of drilling with drilling depths that are many times greater than the diameters. According to VDI Guideline 3210 (VDI Guideline 3210, Beuth-Verlag Berlin, 2006), deep drilling processes are (cutting or chip-formation) machining processes for the production and machining of bores with diameters between D=0.2 . . . 2000 mm and bore depths that are usually greater than three times, in particular greater than ten times, the diameter. For small bore diameters, length-to-diameter ratios of up to l/D≤100 and in special cases even to l/D=900 can be achieved. For large diameters, the l/D ratio is usually limited by the travel distance of the machine or by its bed length.

Deep drilling (also known as deep bore drilling, deep-hole drilling or gun drilling) is thus a machining process in metalworking in which the drilling depth is significantly greater than the tool diameter. In the context of the present disclosure, deep drilling or deep-hole drilling can be defined as drilling in which the drilling depth is at least three times, in particular at least five times, in particular at least ten times, and in particular at least twenty times as large as the diameter. The deep drilling process is also attractive from an economic point of view, as it can be carried out remarkably quickly and enables a high surface finish and excellent drilling quality during drilling. In addition, deep drilling can distinguish from other common drilling processes by the use of a coolant lubricant (cutting fluid), which is fed under high pressure through the hole to the cutting point on the workpiece.

The coolant lubricant lubricates and cools the area of the hole between the workpiece and the tool and ensures smooth removal of chips during drilling with deep-hole drilling technology. With its large l/D ratios (length or depth: l; diameter: D), the supply of coolant lubricant under high pressure and the associated chip removal from the working area, deep drilling provides a particular challenge in modern machining technology. In deep drilling, a distinction is made between three typical deep drilling methods: (1) deep drilling with single-lip drills (single-lip deep hole drilling), (2) deep drilling by BTA deep drilling according to the boring and trepanning association principle, and (3) deep drilling with ejector deep drills.

With single-lip drills, the coolant lubricant is fed through a coolant channel integrated in the tool and removed with the chips through a V-shaped groove in the drill shaft, the so-called gullet. Single-lip drills can be used for holes with a typical drilling diameter of 0.5 to approximately 200 mm. For this deep drilling method, the coolant lubricant is pumped through the coolant channel of the drill with sufficient pressure, exits at the cutting head and flows past the cutting edge of the drill. The single-lip deep drilling with the single-lip drill can be implemented if a sufficiently large amount of coolant lubricant is available during drilling.

BTA drilling stands for “Boring and Trepanning Association.” In this deep drilling method, the coolant lubricant is fed in from the outside and the chips are discharged from the inside. The coolant lubricant of the deep drilling machine is fed to the deep drilling tool (core drilling tool) by means of a drilling oil feed device and a special seal. BTA drilling is a so-called single tube system, as it only requires a single drill pipe for deep drilling. This makes it particularly suitable for large series or series production in the area of deep drilling in contract manufacturing. In BTA drilling, the drill core is drilled out of the borehole.

Ejector deep drilling is a variant of the BTA deep drilling process in which the coolant lubricant is fed to the workpiece or the cutting point via an ejector connection piece. The coolant lubricant is fed through a space between the drill pipe and the inner pipe, which is why the method is also called the “two-pipe method.” With this type of deep drilling, the chips are transported to the outside through an inner pipe.

In addition to metals such as steels and non-ferrous metals, other materials such as acrylic glass, thermosetting and thermoplastic plastics, and hardwood can also be deep-drilled.

One challenge in deep-hole drilling is that the deep drill must be guided precisely in order to achieve a drill path that is as straight as possible, i.e., a center line with as little deviation as possible. Similar challenges generally arise with tools for (cutting) machining workpieces with an elongated shaft, which are generally used for (cutting or chip formation) machining and/or forming workpieces.

WO 2005/072897 A2 discloses a device for drilling bores into a workpiece with a diameter D of a drill and a depth of the borehole, wherein the ratio of depth to diameter D is greater than 100. An additional external measuring device is provided so that the borehole can be drilled with the desired spatial longitudinal progression. The external measuring device has a measuring head with which the spatial longitudinal course of the borehole or the current position of the drill head of the drill can be measured. This is done by measuring a radial distance of the drill head or the borehole from a surface of the workpiece closest to the borehole. The measuring head of the external measuring device is mounted on a measuring head carrier, with the aid of which it can be moved along the surface of the workpiece to be machined and oriented in its spatial position relative to the workpiece to be machined.

In other words, in the prior art, a measurement is performed with an external measuring device transverse to the longitudinal direction of the borehole through the workpiece to be machined. The inventors have recognized that a problem with this approach is that, in the case of complex workpieces with a large number of bores or complex surfaces, artifacts can occur during measurement and it is not possible to measure the center line with the required accuracy.

Against this background, it is an object of the present invention to provide a tool for machining a workpiece, in particular a deep-hole drill, as well as a corresponding system and method, which can contribute to achieving an improved drilling result. In particular, it would be desirable to enable improved monitoring of the machining process even in complex workpieces, in particular with a plurality of adjacent deep holes with high accuracy.

The claimed subject matter is defined in the independent claims. Advantageous embodiments and refinements are described in the dependent claims.

According to a first aspect of the invention, it is proposed to provide a tool for machining a workpiece, in particular for machining a workpiece by cutting or chip formation, in particular a deep-hole drill, comprising
an elongated shaft having a first shaft end and a second shaft end (opposite in the longitudinal direction),
a tool head arranged at the second shaft end, wherein
the shaft comprises a measuring channel for optical measuring radiation, wherein the measuring channel extends from the first shaft end to the second shaft end,
wherein the measuring channel comprises an optical measuring surface at an end facing the second shaft end, wherein the optical measuring surface is configured to reflect optical measuring radiation coupled in via the first shaft end at least partially back to the first shaft end, wherein the optical measuring surface is configured to vary a property of the back-reflected measuring radiation as a function of a relative position of the first shaft end with respect to the second shaft end.

According to a further aspect of the present invention, a tool system for machining a workpiece, in particular for deep-hole drilling, is provided comprising
a tool for machining a workpiece, in particular for deep-hole drilling, as described above and to be explained in the following;
an optical transmitter which is configured to couple optical measuring radiation via the first shaft end of the tool and to transmit the optical measuring radiation to the optical measuring surface;
an optical receiver which configured to receive the measuring radiation reflected back from the optical measuring surface of the tool to the first shaft end.

According to a further aspect of the present invention, a measuring method for machining a workpiece, in particular for deep-hole drilling, is provided comprising the steps:
providing a tool system comprising a tool as described above and to be explained in the following;
coupling optical measuring radiation via the first shaft end and transmitting the optical measuring radiation to the optical measuring surface with the optical transmitter;
receiving the measuring radiation reflected back from the optical measuring surface to the first shaft end with the optical receiver;
determining the relative position of the first shaft end with respect to the second shaft end based on the measuring radiation reflected back from the optical measuring surface and received by the optical receiver with the evaluation device.

The inventors recognized that, with tools for machining a workpiece having an elongated shaft and a tool head arranged at the end of this shaft, position deviations of the tool head can occur, in particular axial deviations from a central axis. It would therefore be desirable to in particular be able to determine the center line. In experiments, a deviation of up to 8 mm was for example measured over a length of 1700 mm during deep drilling. In particular, high feed rates for fast material processing can lead to deviations from the center line. However, high working speeds are essential for economical manufacturing of workpieces.

While it is possible to determine the position of the tool head or the course of the drill hole in the workpiece using solutions known from the prior art, such as in the aforementioned WO 2005/072897 A2, with measurement from the outside, for example using ultrasound. However, a disadvantage of these known solutions is that the measurement of axial deviations from the outside is only possible to a limited extent, for example in prismatic devices. Accurate measurement is also not possible for devices with shadowings, excessively large residual wall thicknesses, or holes located one behind the other. The method described in the prior art therefore has a narrowly defined scope of application for external measurements, mainly on cylindrical devices.

It is therefore suggested that the elongated shaft of the tool for machining the workpiece already comprises a measuring channel for optical measuring radiation. A defined optical measuring surface is provided at the second shaft end, i.e., the shaft end towards the tool head. This allows the measurement to be carried out within the tool itself without being affected by complex geometries of the workpiece or by already existing bores in the workpiece. The optical measuring surface can thereby be provided directly at the shaft end, i.e. between the shaft end and a tool head. This facilitates manufacturing thanks to the very good accessibility. Furthermore, an existing shaft can also be easily retrofitted by attaching a respective optical measuring surface to the shaft end or inserting it into the measuring channel in the area of the shaft end, for example in an already existing coolant lubricant channel. The optical measuring surface is configured to reflect optical measuring radiation coupled in via the first shaft end at least partially back to the first shaft end. Thereby, the optical measuring surface is further configured to vary a property of the back-reflected measuring radiation depending on the relative position of the first shaft end to the second shaft end. The back-reflected measuring radiation can be received by an optical receiver arranged at the first shaft end facing away from the tool head and evaluated. For example, a bend in the shaft transverse to the longitudinal direction leads to an axial deflection of the reflected beam. In this case, the varied property of the back-reflected measurement radiation is the varied direction of back-reflection. Thus, an angle at the second shaft end or at the tool head and thus an orientation of the tool head in the workpiece can be determined by the optical receiver measuring the axial deflection. For this purpose, the optical receiver can comprise several sensor surfaces or can be configured as a quadrant sensor. Furthermore, a torsion of the elongated shaft causes the first shaft end, at which the optical receiver receives the back-reflected measurement radiation, and the second shaft end, at which the tool head is arranged, to be rotated relative to each other. The optical measuring surface can, for example, comprise a gray gradient filter or a polarizing filter in a torsion plane transverse to the longitudinal direction of the shaft, so that the intensity of the back-reflected measuring radiation varies depending on the rotation of the first shaft end relative to the second shaft end. The relative position of the first shaft end to the second shaft end can thus be monitored during the machining process of the workpiece. In particular, a momentary deviation of the tool head of a hollow tool having a long shaft from a tool center can be determined. This allows to determine a time-dependent absolute position of the head position of the tool head to even in a confined/enclosed space, even with complex surrounding geometries that would make measurement from the outside impossible.

The proposed tool can be used, in particular in real time, to measure one or more of bending, compression, and torsion in an elongated shaft of a tool for machining a workpiece, in particular in a deep-hole drill.

The tool head can comprise at least one cutting edge for machining the workpiece. However, it is also possible to provide two or more cutting edges. Preferably, an asymmetrical cutting edge can be provided. If the tool is at different angular positions subjected to different pressures in the feed direction or in the longitudinal direction of the shaft, a direction in which the tool moves through the workpiece to be machined can be influenced. For example, a deep-hole drill can thereby be steered to a certain extent. By evaluating the optical measuring radiation reflected back from the optical measuring surface arranged in the region of the second shaft end, the relative position of the shaft end with respect to the tool head can be determined. This enables more accurate control and thus higher precision.

The tool can be a deep-hole drill, wherein the tool head comprises a drill head or a drill tip with at least one cutting edge. In particular, in the case of very long bores with a small diameter or a large ratio of length to diameter, deviations from the tool center can easily occur. With the proposed solution, these can be monitored and optionally corrected via an additional actuator not defined in further detail herein or by variation of the feed.

The optical measuring surface can be configured to vary an intensity of the back-reflected measuring radiation as a function of the rotation of the first shaft end relative to the second shaft end. For example, the optical measuring surface can comprise a gray gradient filter. In particular, an angle-dependent gray gradient filter can be provided, which is configured to vary the intensity of the back-reflected measuring radiation as a function of the rotation of the first shaft end relative to the second shaft end.

Alternatively or additionally, the optical measuring surface can be configured to vary a polarization of the back-reflected measuring radiation as a function of a relative position of the first shaft end with respect to the second shaft end. For example, the optical measuring surface can comprise an optical polarization filter.

An advantage of the above embodiments can be that from the intensity of the back-reflected measurement radiation information about a relative position, in particular a torsion or rotation of the elongated shaft, can be obtained. In particular at high feed rates, a higher force can act on a cutting edge of the tool head and cause the shaft to twist about its longitudinal axis. With a tool length or shaft length of 1700 mm, a typical torsion can be in the range of 0-30°, in particular in the range of 0-10°, in particular in the range of 0-5°. An advantage of the gray gradient filter is its simple and inexpensive manufacture. An advantage of the polarization filter is that the torsion can be determined independent of a lateral deviation, in particular essentially independently of any bending or deflection of the shaft transverse to the longitudinal direction.

The optical polarization filter can comprise a polarization direction which is rotated relative to a polarization direction of the measuring radiation by an angle between 30° and 60°. An advantage of this embodiment can be increased sensitivity. Since the polarization filter is already rotated relative to the measuring radiation, for example by 45°, even small angle changes cause a large change in the reflected measuring radiation. If, on the other hand, the polarization direction of the polarization filter corresponded approximately to the polarization of the measuring radiation, small angle changes would only cause a small change in intensity.

The measuring channel can be formed at least in sections by a rod made of a medium transparent to the measuring radiation, in particular a glass rod. Hereby, the rod can be made of the transparent medium configured to cause a change in polarization of the measuring radiation, in particular as a function of the mechanical stresses. In other words, a change in the polarity of the measuring radiation can be caused not only by a polarization filter on the measuring surface, but alternatively or additionally also already in the course of the measuring channel by a rod made of a medium transparent to the measuring radiation. Mechanical stress in particular in particular refers to mechanical stress acting on the shaft and/or on the rod, which can be caused by torsion, bending, or compression of the shaft and/or rod.

The optical measuring surface can comprise a waveplate, in particular a λ/4 or λ/2 plate. This is a further possibility of influencing a property of the reflected measuring radiation in order to make a determination about the relative position of the first shaft end to the second shaft end from the reflected measuring radiation.

The measuring channel can be an inner hollow channel of the shaft. An advantage of this embodiment can be that the optical measuring radiation can be guided protected within the shaft. For example, it can be prevented that chips removed from the workpiece falsify a measurement result.

Optionally, the tool can comprise at least one additional coolant lubricant (cutting fluid) channel, wherein the measuring channel and the coolant lubricant channel are separated from one another. In the context of the present disclosure, a coolant lubricant channel can refer to a channel for a cooling and/or lubricating agent. Such coolant lubricants are usually provided during machining. The coolant lubricant channel can be connected to a coolant lubricant outlet at the tool head. An advantage of this solution can be that the measuring channel is protected from disturbances. Optionally, the measuring channel can be configured as a rod made of a transparent medium, in particular as a glass rod. In particular, the rod made of the transparent medium or glass rod can be arranged in an already existing coolant lubricant channel or inserted into it. This facilitates manufacture, since the radiation guiding region can due to displacement automatically be regarded as oil-tight. For example, existing shaft profiles can be used and retrofitted by a measuring channel. In addition to a coolant lubricant channel for supplying the coolant lubricant, a further coolant lubricant channel can be provided for removing the coolant lubricant and any chips produced during machining of the workpiece.

The shaft can comprise a coolant lubricant channel for a coolant lubricant, which is connected to a coolant lubricant outlet at the tool head, wherein the optical measuring surface is arranged inside the coolant lubricant channel. In other words, the optical measuring surface can be arranged directly within the coolant lubricant channel. It is thus not necessary to provide a separate coolant lubricant channel for supplying coolant lubricant. Instead, the measuring channel and the coolant lubricant channel are formed by the same channel. This provides a synergy effect, since the coolant lubricant can be fed directly into the measuring channel. Thereby, the tool can be manufactured easier and more cost-effective.

In a further refinement, the optical measuring surface can be held in the coolant lubricant channel by one or more holders projecting into the coolant lubricant channel. In particular, the optical measuring surface can comprise one or more passage openings for the coolant lubricant.

A wavelength of the optical measuring radiation and a transmission spectrum of the coolant lubricant can be adapted to each other such that the coolant lubricant is transparent to the optical measuring radiation. In other words, a wavelength or a spectrum of the optical transmitter can be adapted to a transmission of the coolant lubricant. Alternatively, a transmission of the coolant lubricant can be adapted to the wavelength of the optical transmitter. The measuring radiation can thus be guided together with the coolant lubricant in the same channel. It is to be understood that transparent in this context means that sufficient optical transmission is provided to perform the measurement, for example a transmission of at least 50%, in particular of at least 70%, in particular of at least 80%, in particular of at least 90%.

The optical measuring surface can be formed in a plane transverse to a longitudinal direction of the elongated shaft as a circular arc section. In particular, the optical measuring surface can be configured as a circular arc-shaped gray gradient filter, wherein the intensity of the back-reflected optical measuring radiation varies depending on a position on the circular arc, for example, increases or decreases continuously as a function of angle. In the context of the present disclosure, a gray gradient filter is understood to be an optical element that causes the intensity of the reflected measurement radiation to increase or decrease continuously. In particular, if the measuring channel and the coolant lubricant channel are formed by a common channel in the elongated shaft, the embodiment of the optical measuring surface as a circular arc section can be advantageous, since sufficient space can be provided for a coolant lubricant flow.

A ratio of a length of the shaft to a diameter of the tool head can have a value of at least 3, in particular of at least 5, in particular of at least 10, in particular of at least 20, in particular of at least 50. In particular, the tool can be a deep-hole drill. It is to be understood that the elongated shaft can also be configured in multiple pieces, i.e., composed of several parts. It is also possible that additional shaft sections can be inserted between the tool head and a drive device during a drilling operation in order to achieve a desired drilling depth.

The tool head can have a diameter of at least 5 mm, in particular at least 10 mm, in particular at least 15 mm. For example, the tool head has a diameter of 18-21 mm and the elongated shaft has a length of at least 1500 mm, in particular a length of 1700 mm.

The tool system can further comprise an evaluation device configured to determine a relative position of the first shaft end with respect to the second shaft end based on the measurement radiation received by the optical receiver and reflected back from the optical measuring surface. The evaluation device can be provided as a separate unit, for example by a computer, a microprocessor, a microcontroller or any other computing device which is configured to evaluate measurement data based on measurement signals from the optical receiver.

The tool system can comprise a drive device and/or feed device for the tool and a control device, wherein the control device is configured to control or regulate the drive device and/or feed device in dependence on (as a function of) the measuring radiation detected by the optical receiver and reflected back from the measuring surface at the second shaft end. If, for example, a deviation from a desired position is detected, a position correction can be made. For example, as described above, a tool with an asymmetrical cutting edge arrangement can be provided and a change of direction in the workpiece can be effected by applying pressure to the tool in a manner which varies as a function of the angle.

The optical receiver (optical sensor) can comprise a plurality of light-sensitive sensor areas. In particular, the optical receiver can be a quadrant sensor or, more generally, be configured as a sensor with several sensor areas. If, for example, the optical measuring surface is tilted, the reflected optical measuring radiation is reflected back at an angle so that a deviation of the reflected measuring radiation can be detected by the plurality of light-sensitive sensor areas. Based on a deviation determined on the optical sensor and a length of the shaft or distance between the optical sensor and the optical measuring surface, a tilt angle can thus be determined. By determining the tilt at any point in time and by also tracking the feed of the tool, a position or the center line of, for example, a deep hole can be determined at any time.

Alternatively or in addition, the optical receiver can comprise a polarization sensor. This allows a rotation to be measured as described above. For example, the polarization sensor can comprise an array of sensors with differently arranged polarization filters.

The optical transmitter and/or optical receiver can be arranged in a fixed position with respect to the tool. In particular, the optical transmitter and/or optical receiver can be arranged and configured such that they rotate together with the tool about a longitudinal axis of the shaft during machining of the workpiece. This can be particularly advantageous for tracking angular deviations via the rotation.

In one embodiment, the optical transmitter and the optical receiver can be arranged in a measuring adapter which is arranged between the tool and a drive device and/or feed device for the tool. An advantage of this embodiment can be that existing machines can also be retrofitted with little effort. For example, the measuring adapter can be arranged between a drive spindle of a conventional deep-hole drilling machine and a tool as described in the present disclosure.

It is to be understood that the features mentioned above and those yet to be explained below may be used not only in the combination respectively indicated, but also in other combinations or separately, without departing from the scope of the present invention.

Embodiments of the invention are illustrated in the drawings and are explained in more detail in the following description.

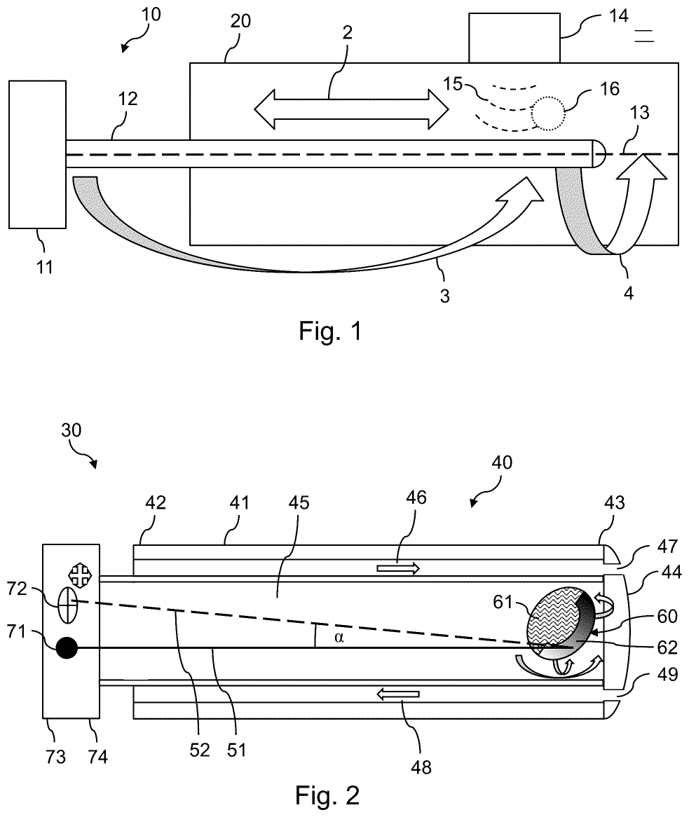

FIG. 1 shows a schematic illustration of a conventional system for deep drilling with a conventional external measuring device;

FIG. 2 shows a schematic illustration of an embodiment of a tool system comprising a tool according to an aspect of the present disclosure;

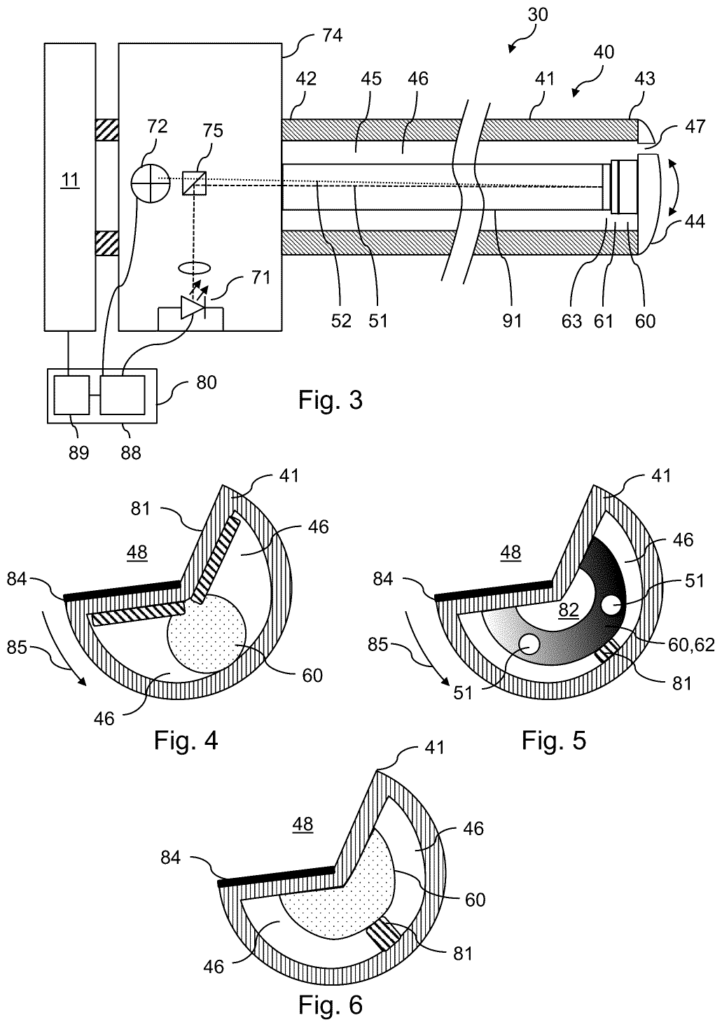

FIG. 3 shows a schematic illustration of a further embodiment of a tool system comprising a tool according to an aspect of the present disclosure;

FIG. 4 shows a first schematic illustration of a tool according to a first embodiment of the present disclosure in a top view in direction of the longitudinal direction of the shaft;

FIG. 5 shows a second schematic illustration of a tool according to a second embodiment of the present disclosure in a top view in direction of the longitudinal direction of the shaft;

FIG. 6 shows a third schematic illustration of a tool according to a third embodiment of the present disclosure in a top view in direction of the longitudinal direction of the shaft;

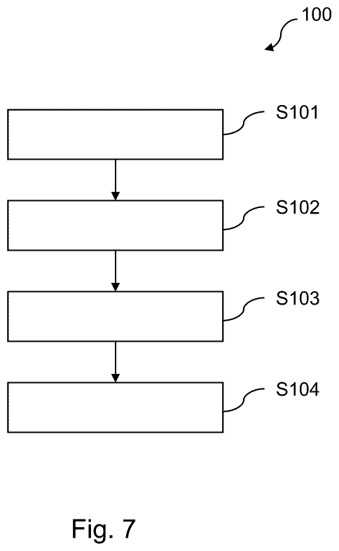

FIG. 7 a flow chart of a method.

FIG. 1 shows a schematic representation of a conventional system 10 for deep-hole drilling. The system 10 comprises a drive device 11 and a deep-hole drill 12 as a tool. As already described above, a challenge in deep-hole drilling is that the deep-hole drill must be guided precisely in order to obtain as accurate a straight drilling path as possible, as illustrated by the dashed line 13. In practice, however, particularly at high machining speeds, deviations from the ideal bore path ant thus in a centerline of the deep hole drill. This is illustrated in FIG. 1 by arrows for compression 2, bending 3, and torsion 4. If one or more of compression 2, bending 3 and torsion 4 of the tool 12 occur during the machining process, this can negatively influence the manufacturing precision and lead to a deviation of the hole from the desired straight hole path.

In the conventional approach shown in FIG. 1, an external measuring device 14 is provided which measures the bore from the outside through the workpiece 20, for example by ultrasound 15. However, artifacts can occur in the case of complex workpiece geometries or geometries with scattering or reflection centers within the workpiece. For example, existing bores, as indicated in FIG. 1 by reference sign 16, can lead to interference signals which make it impossible to accurately determine the center line of the borehole.

FIG. 2 shows a schematic representation of an embodiment of a tool system 30 comprising a tool 40 for machining a workpiece according to an aspect of the present disclosure. In the shown example, there is provided a deep-hole drill. However, other tools for machining a workpiece or tools for forming comprising an elongated shaft are also conceivable. The tool 40 comprises an elongated shaft 41 having a first shaft end 42 and a second, in the longitudinal direction opposite shaft end 43. The tool 40 further comprises a tool head 44 which is arranged at the second shaft end 43. The elongated shaft comprises a measuring channel 45 for optical measuring radiation 51, wherein the measuring channel 45 extends from the first shaft end 42 to the second shaft end 43. The measuring channel 45 comprises an optical measuring surface 60 at an end facing the second shaft end 43. The optical measuring surface 60 is configured to reflect optical measuring radiation 51 coupled in via the first shaft end at least partially back to the first shaft end 42, wherein the optical measuring surface 60 is configured to vary a property of the back-reflected measuring radiation 52 as a function of a relative position of the first shaft end 42 with respect to the second shaft end 43. The optical measuring surface 60 can comprise a mirror which is configured to reflect the optical measuring radiation back. In the figures, the incident path of the optical measuring radiation is denoted by reference sign 51. The return path of the optical measuring radiation or the back-reflected optical measuring radiation is denoted by reference sign 52.

The tool system 30 further comprises an optical transmitter 71 and an optical receiver 72. The optical transmitter 71 is configured to couple optical measuring radiation 51 in via the first shaft end 42 of the tool 40 and to transmit it to the optical measuring surface 60. The optical transmitter can be a laser, for example a laser diode with beam-shaping optics. The optical measuring radiation can be coherent and/or polarized measuring radiation. The optical receiver 72 is configured to receive the measuring radiation 52 reflected back from the optical measuring surface 60 of the tool 40 to the first shaft end 42. The optical receiver 72 can be a photodiode or an array of photodiodes. Preferably, the transmitter 71 and receiver 72 can be arranged in a separate unit 73 which can be flexibly combined with or coupled to different tools 40. For example, the unit 73 can be a measuring adapter 74 which can be arranged between the tool 40 and a drive device and/or feed device for the tool. The drive device (not shown in FIG. 2) can be a conventional drive device 11 as, for example, illustrated in FIG. 1.

In the embodiment shown in FIG. 2, the optical receiver 72 is configured as a quadrant sensor. However, other types of sensors, such as a sensor comprising a pixel array or a polarization sensor, are also possible. If the tool 40 follows a desired straight path, the back-reflected measurement radiation 52 can strike the center of the quadrant sensor. However, if there is a bend in the longitudinal direction, as illustrated by arrow 3 in FIG. 1, the back-reflected measurement radiation 42 is deflected, as illustrated by the angle α between the incident optical measurement radiation 51 and the back-reflected optical measurement radiation 52. Thereby a deviation from a desired straight path can be detected. An amplitude of the deviation is a measure of the tilt of the tool head 44 or the retro-reflective measuring surface 60 at the second shaft end. As already mentioned above, usually only small angular deviations occur during deep-hole drilling, such that an evaluation with a cost-effective quadrant sensor is possible. A further advantage of this embodiment is the compact design, which allows implementation smaller than a diameter of the cutting tool.

The optical measuring surface 60 can comprise a measuring mirror 61 which is configured to reflect the optical measuring radiation at least partially back to the first shaft end. Optionally, the optical measuring surface 60 can further be configured to vary an intensity of the back-reflected measuring radiation 52 as a function of a rotation of the first shaft end 42 relative to the second shaft end 43. This can be a gray gradient filter 62, in particular an angle-dependent gray gradient filter, which is configured to vary an intensity of the back-reflected measurement radiation 52 as a function of a rotation of the first shaft end 42 relative to the second shaft end 43. Thus, when the second shaft end 43 is rotated relative to the first shaft end 42, the measuring radiation is reflected more strongly or more weakly. This difference in intensity can in turn be evaluated to determine a rotation or torsion of the shaft ends relative to one another.

As shown in FIG. 2, the tool 40 can comprise a first coolant lubricant channel 46 and/or a second coolant lubricant channel 48. The first coolant lubricant channel 46 can be a coolant lubricant input of feed channel which can feed coolant lubricant to the tool head 44 via an outlet 47. The second coolant channel 48 can be a coolant lubricant return channel, which via an inlet 49 receives coolant lubricant from the tool head and preferably cutting chips and transports them away. It is to be understood that the second coolant lubricant channel 48 can have a larger diameter than the first coolant lubricant channel 46 in order to enable advantageous removal of the cutting chips.

FIG. 3 shows a schematic illustration of a further embodiment of a tool system 30 comprising a tool 40 according to an aspect of the present disclosure. The tool system comprises a drive and/or feed device 11 and an adapter 74, which is arranged between the drive and/or feed device 11 and the tool 40. The adapter 74 comprises the optical transmitter 71, which is configured to couple optical measuring radiation 51 in via the first shaft end 42 of the tool 40 and to transmit the optical measurement radiation to the optical measuring surface 60. The adapter further comprises the optical receiver 72, which is configured to receive the measuring radiation reflected back from the optical measuring surface 60 of the tool 40 to the first shaft end 42. In the embodiment shown in FIG. 3, a substantially coaxial beam path of the coupled-in measuring radiation 51 and the back-reflected measuring radiation 52 is provided. Hereby, a beam splitter 75 can be provided, which couples the optical measuring radiation 51 into the common beam path. The reflected measurement radiation 52 passes at least partially through the beam splitter and reaches the optical receiver 72.

The tool system 30 further comprises an evaluation device 88 which is configured to determine a relative position of the first shaft end 42 with respect to the second shaft end 43 based on the measuring radiation 52 received by the optical receiver 72 and reflected back from the optical measuring surface 60.

In the embodiment shown in FIG. 3, the tool system 30 optionally further comprises a control device 89 which is configured to control or regulate the drive device and/or feed device 11 as a function of or in dependence on the measuring radiation 52 detected by the optical receiver 72 and reflected back by the measuring surface at the second shaft end, for example as already described above.

The evaluation device 88 and control device 89 can be configured as separate units or as a common unit 80. For example, an industrial control or a microcontroller can be provided. However, it is also possible to provide a control computer which is configured with program instructions to perform the functions of the evaluation device 88 and/or control device 89.

In the embodiment shown in FIG. 3, the optical measuring surface 60 comprises a measuring mirror 61 and a polarizing filter 63 arranged on top. If polarized measuring radiation, for example from a laser as an optical transmitter 71, passes through the polarization filter 63, it is reflected at the measuring mirror 61, passes through the polarization filter 63 again and is directed to the optical receiver 72 via the beam splitter 75. If the polarization filter 63 is rotated relative to the polarization of the laser light of the incident measuring radiation 51, this leads to a partial attenuation of the reflection. The intensity of the light received by the optical receiver 72 therefore depends on a torsion or rotation of the tool 40. Optionally, the optical receiver 72 can again comprise several pixels in order to also be able to detect a bending of the tool 40.

In the embodiment shown in FIG. 2, the measuring channel 45 and the coolant lubricant channel 46 are separated from each other. In the embodiment shown in FIG. 3, a common channel 45, 46 is provided, which serves both as a measuring channel 45 and as a coolant lubricant channel 46. This common channel is connected to a coolant lubricant outlet 47 at the tool head 44. The optical measuring surface 60 is arranged inside the coolant lubricant channel 46. An advantage of this embodiment is that the optical measuring radiation 51, 52 and the coolant lubricant can be guided in a common channel and the tool is therefore less complex in design. Hereby, a wavelength of the optical measuring radiation and a transmission spectrum of the coolant lubricant can be adapted to each other such that the coolant lubricant is transparent to the optical measuring radiation. Separate guiding of the optical measuring radiation is thus not necessary.

FIGS. 4, 5 and 6 show three exemplary schematic illustrations of tools 40 in viewed in a direction in the longitudinal direction of the shaft from the first end 42 towards the second end 43, as shown in FIGS. 2 and 3. The shaft 41 of the tool 40 is configured as a hollow tube. The interior of the tube thereby illustrates the first coolant lubricant channel 46, similar to shown in FIG. 3. The second coolant lubricant channel 48 for returning the coolant lubricant and removing the chips can be arranged outside the shaft 41. Such a shaft 41 can be produced, for example, by an extrusion process or by deformation of an originally circular starting body, on the basis of which the coolant lubricant channel 48 is formed with a wedge shape by deformation from the outside. The optical measuring surface 60 is in turn arranged inside the shaft 41 inside the first coolant lubricant channel 46. The optical measuring surface 60 can be held in the coolant lubricant channel 46 by one or more holders 81 projecting into the coolant lubricant channel 46. In order not to constitute an unduly large obstruction to the flow of the coolant lubricant, the optical measuring surface 60 can comprise one or more passage openings 82 for the coolant lubricant. The respective cutting edges 84 are also illustrated. During machining of the workpiece, a force acts on the cutting edge 84, which leads to torsion of the shaft 41, as illustrated by the arrow 85 in FIG. 4 and FIG. 5.

In the embodiments shown in FIG. 4 and FIG. 6, the optical measuring surface 60 is provide by a measuring mirror 61 and a polarizing filter 63, as for example illustrated in FIG. 3. In the embodiment shown in FIG. 5, however, a circular arc-shaped gray scale filter is provided. Depending on where the measuring radiation 51 strikes the gray scale filter, the measuring radiation is reflected back to the optical receiver with different intensities. Based on this, a information can be obtained about a torsion of the second shaft end 43 of the tool 40 relative to the first shaft end 42.

In a modification of the embodiment shown in FIG. 3, a glass rod 91 can optionally be provided, in which the optical measuring radiation 51 is guided at least in sections from the first shaft end 42 to the second shaft end 43 and the reflected measuring radiation 52 is guided back from the second shaft end 43 to the first shaft end 42. This can reduce the transparency requirements for the coolant lubricant. However, the construction is further simplified because no separate channel needs to be provided, instead, the glass rod 91 is simply inserted into the existing coolant lubricant channel 46. In the context of the present disclosure, a glass rod is understood to be an elongated body that is transparent to the measuring radiation and can be inserted into the shaft 41.

FIG. 7 shows a flow chart of a method 100 for machining a workpiece, in particular for cutting or chip removing machining, in particular for deep-hole drilling. In a first step S101, a tool system comprising a tool as described in the present disclosure is provided. In a second step S102, optical measuring radiation is coupled in via the first shaft end with the optical transmitter and transmitted to the optical measuring surface. In a third step S103, the measuring radiation reflected back from the optical measuring surface to the first shaft end is received with the optical receiver. In a fourth step S104, a relative position of the first shaft end with respect to the second shaft end is determined with the evaluation device based on the measuring radiation reflected back from the optical measuring surface and received by the optical receiver. The determined relative position can be further processed in subsequent steps. For example, a center line can be mapped during deep drilling via a progression of the respective relative positions over time and documented for quality assurance purposes, for example. However, it is also possible that the determined relative position is used to regulate or control the machining process, as already described above.

In conclusion, the proposed solution allows monitoring of a material processing operation, in particular during deep-hole drilling. A displacement of a measuring beam, such as a laser reference beam, can be detected depending on the axial, radial, and/or transverse displacements of a long-shaft tool. The optical transmitter, in particular a laser beam source which emits coherent light waves, emits the measuring radiation through the measuring channel through the tool shaft. An optical measuring surface, for example a mirror mounted at the end towards the tool head, preferably with a polarization filter/grey gradient filter applied, which is displaced in the same way due to the fixation to the tool head, reflects the measuring radiation onto an optical sensor, for example onto a 4-quadrant/4-point polarization filter. gray gradient filter, which is displaced equally by being fixed to the tool head, reflects the measuring radiation onto an optical sensor, such as a 4-quadrant/photo sensor. With the measuring signal from the optical sensor, for example the measurement of the output voltages/currents at the 4-quadrant/photo sensor, it is possible to determine, on the one hand, the attenuation of the intensity of the measuring beam, for example an attenuation of the power of the laser beam by the gray gradient filter or the rotation of the polarization direction due to the polarization filter, and on the other hand the displacement of the laser point by the tilting of the mirror.

With the solutions proposed herein, a tool for machining a workpiece, in particular a deep-hole drill, as well as a corresponding tool system and method can be provided, which can contribute to achieving an improved drilling result. In particular, an improved monitoring of the machining process can be provided even for complex workpieces, in particular with a plurality of adjacent deep holes, with high accuracy.

1-25. (canceled)

26. A tool for machining a workpiece, the tool comprising:
an elongated shaft having a first shaft end and a second shaft end opposite the first shaft end; and
a tool head arranged at the second shaft end, wherein the elongated shaft comprises a measuring channel for optical measuring radiation, and wherein the measuring channel extends from the first shaft end to the second shaft end, the measuring channel comprising:
an optical measuring surface at an end facing the second shaft end, wherein the optical measuring surface is configured to reflect optical measuring radiation coupled in via the first shaft end at least partially back to the first shaft end, and wherein the optical measuring surface is configured to vary a property of back-reflected measuring radiation as a function of a relative position of the first shaft end with respect to the second shaft end.

27. The tool of claim 26, wherein said tool is a deep-hole drill, and wherein the tool head includes a drill head with at least one cutting edge.

28. The tool of claim 26, wherein the optical measuring surface is configured to vary an intensity of the back-reflected measuring radiation as a function of a rotation of the first shaft end relative to the second shaft end.

29. The tool of claim 26, wherein the optical measuring surface includes a gray gradient filter.

30. The tool of claim 29, wherein the gray gradient filter is an angle-dependent gray gradient filter which is configured to vary an intensity of the back-reflected measuring radiation as a function of a rotation of the first shaft end relative to the second shaft end.

31. The tool according to claim 26, wherein the optical measuring surface includes an optical polarizing filter.

32. The tool of claim 31, wherein the optical polarizing filter has a polarization direction which is rotated relative to a polarization direction of the measuring radiation by an angle between 30° and 60°.

33. The tool of claim 26, wherein the optical measuring surface is configured to vary a polarization of the back-reflected measuring radiation as a function of a relative position of the first shaft end with respect to the second shaft end.

34. The tool of claim 26, wherein the measuring channel is formed at least in sections by at least one of a rod made of a medium that is transparent to the measuring radiation or a glass.

35. The tool of claim 26, wherein the optical measuring surface includes a waveplate, and wherein the waveplate is a λ/4 plate.

36. The tool of claim 26, further comprising:
at least one coolant lubricant channel, wherein the measuring channel and the coolant lubricant channel are separated from one another.

37. The tool of claim 26, wherein the elongated shaft includes a coolant lubricant channel for a coolant lubricant, the coolant lubricant channel connected to a coolant lubricant outlet at the tool head, and wherein the optical measuring surface is arranged inside the coolant lubricant channel.

38. The tool of claim 37, wherein a wavelength of the optical measuring radiation and a transmission spectrum of the coolant lubricant are adapted to each other such that the coolant lubricant is transparent to the optical measuring radiation.

39. The tool of claim 26, wherein the optical measuring surface is configured as a circular arc section in a plane transverse to a longitudinal direction of the elongated shaft.

40. A tool system for machining a workpiece, the tool system comprising:
a tool comprising:
an elongated shaft having a first shaft end and a second shaft end opposite the first shaft end; and
a tool head arranged at the second shaft end, wherein the elongated shaft comprises a measuring channel for optical measuring radiation, and wherein the measuring channel extends from the first shaft end to the second shaft end, the measuring channel comprising:
an optical measuring surface at an end facing the second shaft end, wherein the optical measuring surface is configured to reflect optical measuring radiation coupled in via the first shaft end at least partially back to the first shaft end, and wherein the optical measuring surface is configured to vary a property of back-reflected measuring radiation as a function of a relative position of the first shaft end with respect to the second shaft end;
an optical transmitter configured to couple the optical measuring radiation via the first shaft end of the tool and to transmit it to the optical measuring surface; and
an optical receiver configured to receive the optical measuring radiation reflected back from the optical measuring surface of the tool to the first shaft end.

41. The tool system of claim 40, wherein the optical receiver comprises a plurality of light-sensitive sensor areas, and wherein the optical receiver is a quadrant sensor.

42. The tool system of claim 40, wherein the optical receiver comprises a polarization sensor.

43. The tool system of claim 40, wherein the optical transmitter and/or optical receiver are arranged in a fixed position with respect to the tool and configured to rotate together with the tool about a longitudinal axis of the elongated shaft during said machining of said workpiece.

44. The tool system according to claim 40, wherein the optical transmitter and the optical receiver are arranged in a measuring adapter which is arranged between the tool and a drive device and/or feed device for the tool.

45. A measuring method for chip formation machining a workpiece for deep-hole drilling, comprising the steps:
providing a tool system comprising a tool with an elongated shaft having a first shaft end and a second shaft end opposite the first shaft end and an optical measuring surface configured to reflect optical measuring radiation coupled in via the first shaft end at least partially back to the first shaft end and to vary a property of back-reflected measuring radiation as a function of a relative position of the first shaft end with respect to the second shaft end;
coupling the optical measuring radiation via the first shaft end and transmitting the optical measuring radiation to the optical measuring surface with an optical transmitter;
receiving the measuring radiation reflected back from the optical measuring surface to the first shaft end with an optical receiver; and
determining a relative position of the first shaft end with respect to the second shaft end based on the measuring radiation reflected back from the optical measuring surface and received by the optical receiver with an evaluation device.
